(19) United States
(12) Patent Application Publication
(10) Pub. No.: US 2004/0139013 A1
(43) Pub. Date: Jul. 15, 2004

(54) Remote electronic payment system

(76) Inventors: Eric Barbier, Paris (FR); Christophe Dolique, Suresnes (FR); Charles Guillot, New York City, NY (US)

Correspondence Address: YOUNG & THOMPSON, 745 SOUTH 23RD STREET 2ND FLOOR, ARLINGTON, VA, 22202

(21) Appl. No.: 10/468,476

(22) PCT Filed: Feb. 19, 2002
(86) PCT No.: PCT/FR02/00626

(30) Foreign Application Priority Data
Feb. 20, 2001 (FR) 01/02262

(51) Int. Cl. G06F 17/60

(52) U.S. Cl. 705/40

(57) ABSTRACT

The invention concerns a remote electronic payment system comprising an authentication device (300) with an authenticating server in a remote payment system, the authentication being performed prior to a transaction carried out by a user. The device (300) is characterised in that it comprises: means (310) for receiving a first authentication request, from the authenticating server; means (330) for verifying the validity of the authentication request; means (350) for validation, by the user, of the transaction; means (370) for controlling said user's identity; and means (380) for sending a return message of authentication, to the authenticating server (900).

The present invention relates to a remote electronic payment system.

An aim of the invention is in particular an authentication device for authentication with an authentication server in a remote payment system for executing transactions from a mobile phone.

Currently, there is no method for authenticating a user prior to a remote ote payment operation that is not dependent on a smart card reader.

Furthermore, in a known first category of electronic devices for carrying out remote transactions, the user is requested to enter references of a payment means, such as a credit card. These references are, in a known way, encrypted and transmitted to the remote supplier.

Such electronic devices must have a user interface for easily entering these references. This is not the case in particular for mobile telephones, the keypad and display of which are generally of reduced size.

Also known are mobile telephones having an integrated credit card reader. With this solution, the need to enter—the abovementioned references is effectively eliminated. In addition, this solution enables an authentication prior to a payment operation. However, this solution requires complex and costly components.

Furthermore, it seems that most consumers are hesitant about providing their supplier with references of a payment means, and even more so over a communication network.

Also known in the field of electronic commerce over the Internet are remote electronic payment systems for which the references of a payment means are stored on a server known as a “server-based electronic wallet”. In such a system, the user authenticates himself with the remote server-based electronic wallet, from a client terminal, for example a personal computer (PC) with authentication means typically incorporated in an Internet browser.

Most mobile telephones, in particular those that do not have Internet browsers, do not provide such authentication means. Mobile telephones making use of WAP (Wireless Access Protocol) also do not provide such means. They can therefore not be used as client terminals for a user to authenticate himself with a server-based electronic wallet.

The aim of the present invention is to solve this problem by proposing in particular an authentication device designed to be incorporated in a mobile telephone.

To this end, the present invention proposes an authentication device for authentication with an authentication server in a remote payment system, the authentication being prior to a transaction by a user, the device being characterized in that it includes:

means for receiving a first authentication request from the authentication server;

means for verifying the validity of the authentication request;

means of validation, by the user, of the transaction;

means for checking the identity of the user; and

means for sending a return authentication message to the authentication server.

Correlatively, a subject of the invention is a method of authentication with an authentication server in a remote payment system, the authentication being prior to a transaction by a user, the method being characterized in that it includes the following steps:

reception of a first authentication request from the authentication server;

verification of the validity of the authentication request;

validation, by the user, of the transaction;

check on the identity of the user; and

sending of a return authentication message to the authentication server.

Since the particular features and advantages of the authentication method are similar to those of the authentication device, they will not be detailed here.

Thus, the invention is used first to authenticate the user before validating the transaction. In addition, the sending of the return authentication message takes place after a verification of the validity of the authentication request. This measure is for ensuring that the return authentication message is not sent to a malicious recipient.

According to one particular feature, the authentication request includes a description of the transaction, an identifier of the transaction and a first authentication code from the authentication server, the verification means of the authentication device being designed to verify the validity of the authentication request from the first authentication code and from a first authentication key.

This key-based authentication mechanism enables the validity of the authentication request to be verified with a great degree of reliability.

According to another particular feature, the authentication device additionally includes means for generating a second authentication code, the means for sending the return authentication message being designed to insert this second authentication code into the return authentication message.

This mechanism is for ensuring, at the authentication server, that the return authentication message is actually from the authentication device.

According to a preferred feature, the means for sending the return authentication message are designed to insert a response, that is dependent on the validation of the transaction, into the return authentication message.

The return authentication message may for example contain data representing the acceptance of the transaction by the user, which data may be transmitted by the authentication server to a financial establishment.

According to a preferred feature, the means for checking the identity of the user make use of a personal identification number.

This personal identification number, which the user will have received by mail for example, will prevent the authentication device being used by a third party. In a known manner, the means for checking the identity of the user can for example be designed to block the authentication device after three entries of an incorrect personal identification number.

According to a preferred feature, the authentication device additionally includes means for decrypting the first authentication request, based on a transport key, and/or means for encrypting the return authentication message, based on a transport key.

This advantageous feature significantly increases the confidentiality of the transaction.

According to another feature, since the transaction includes a payment operation, the device includes means for selecting a payment option for the transaction and the means for sending the return authentication message are designed to insert this option into the return authentication message.

In particular, this feature means that a remote electronic payment service that is not dependent on one payment option can be offered. It is even entirely conceivable that these payment means are virtual, or dedicated to this remote electronic payment service. Even if pirated, they are not in this case of any use to a malicious user, and this further strengthens the security of the system.

According to another particular feature, the authentication device additionally includes a transaction counter used by the means for generating the second authentication code and inserted by the means for sending the return authentication message into the return authentication message.

This identifier can thus be used to uniquely identify each return authentication message.

According to another particular feature, the authentication device includes means for receiving, from an activation server, a key delivery message, the key delivery message including the first authentication key.

The authentication key is thus supplied by a server, preferably in a manner that is transparent to the user, and this helps to strengthen the security of the system.

According to another particular feature, the key delivery message additionally includes a personal unblocking identification number.

Conventionally, this personal unblocking identification number is used to unblock the authentication device when the latter has been blocked, for example after three entries of an incorrect personal identification number.

According to another particular feature, the authentication device additionally includes means for verifying the validity of the key delivery message, based on a third authentication code contained in the key delivery message.

Another aim of the invention is an activation server, in a remote payment system, characterized in that it includes:

means for receiving an activation request from a user account server, the activation request including an identifier of an authentication device of the type described above;

means for generating the first authentication key; and

means for sending, on receipt of a response to the activation request, the key delivery message to the authentication device.

It is thus the activation server's responsibility to generate the authentication key.

According to a particular feature, the identifier is a telephone number.

According to another particular feature, the activation server additionally includes means for saving the first authentication key in a secure database.

The activation server thus keeps a copy of the first authentication key. This key may be transmitted later to an authentication server that will be able to operate a symmetric key infrastructure authentication mechanism with the authentication device.

According to another feature, the activation server includes means for generating a second authentication key, from the first authentication key, and includes means for saving this second authentication key in the secure database.

This second key may then be transmitted later to an authentication server that will be able to operate an asymmetric key infrastructure authentication mechanism with the authentication device.

According to another particular feature, the activation server includes means for computing a third authentication code, this third authentication code being inserted into the key delivery message.

This mechanism enables the authentication device to ensure that the key delivery message is valid.

According to another particular feature, the activation server inserts a personal unblocking identification number into the key delivery message.

As described above, this personal unblocking identification number is used to unblock the authentication device when the latter has been blocked, for example after three entries of an incorrect personal identification number.

According to another particular feature, the activation server additionally includes means for encrypting the key delivery message, based on a transport key.

This advantageous feature considerably increases the confidentiality of the activation message.

According to another particular feature, the activation server additionally includes means for obtaining the transport key and a personal unblocking identification number from a preactivation database.

This transport key can also be used to compute the third authentication code.

This preactivation database is typically a generic database updated for each creation of an authentication device. In particular, it enables the operator of the payment system to maintain control over the authentication devices.

According to another particular feature, the activation server includes means for sending an authentication registration to an authentication server, the authentication registration including the transport key and the personal unblocking identification number.

The authentication server will thus possess the transport key enabling it to securely exchange messages relating to the transactions with the authentication device.

Correlatively, an aim of the invention is a user account server, in a remote payment system, characterized in that it includes:

means for creating and storing at least one user account associated with an authentication device of the type described above;

means for sending an activation request to an activation server of the type described above; and

means for sending a second authentication request to an authentication server.

A user account is thus created for any user in possession of an authentication device of the type described above and actually wanting to use (for example via a subscription) such a remote electronic payment system. After this account has been created, the user account server sends an activation request to the activation server which generates and supplies the authentication key to the user.

According to a particular feature, a user account includes an identifier of the authentication device (for example a telephone number) and at least one payment option for the transaction.

Another aim of the invention is an authentication server, in a remote payment system, characterized in that it includes:

means for receiving at least one authentication registration from an activation server of the type described above,

means for storing the authentication registration;

means for receiving a second authentication request from a user account server of the type described above;

means for sending the first authentication request to an authentication device of the type described above, on receipt of the second authentication request;

means for receiving a return authentication message from the authentication device; and

means for sending a transaction confirmation message to the user account server on receipt of the return authentication message.

Such an authentication server thus receives, upon activation of the service, an authentication registration containing the transport key and the personal unblocking identification number which are associated with an authentication device. For each transaction, it then receives an authentication request from a user account server. It can then send a first authentication request to an authentication device incorporated in a client terminal and receive in return a validation of the transaction from the user together with a payment method. These latter items of information are thus transmitted in a transaction confirmation message to the user account server which ends the actual transaction.

Correlatively, an aim of the invention is a remote payment system, characterized in that it includes an authentication device, an activation server, a user account server and an authentication server, all of which are of the types described above.

According to a particular feature, the remote payment system uses an infrastructure of a mobile telephony network, for example that of a GSM network.

An authentication device can thus be incorporated in a mobile client terminal.

According to another particular feature, the messages and requests described above comply with the SMS format of the GSM network.

This feature means that, advantageously, a specific communication protocol need not be developed for deploying such a remote electronic payment service.

Another aim of the invention is a smart card and a SIM card including an authentication device of the type defined above.

This means that the SIM card's encryption and decryption means, traditionally dedicated to encrypting and decrypting telecommunication messages, can advantageously be used for the encryption and decryption of messages associated with a remote electronic payment.

Another aim of the invention is a telephone including means designed to receive a SIM card of the type defined above.

Thus, such a telephone can thus be used as a client terminal for authentication with a server-based electronic wallet.

According to a particular feature, the telephone additionally includes means for entering the personal identification number.

Thus, and in a known manner, the user can enter his personal identification number, this number having been for example received by mail as confirmation of the subscription.

Other aspects and advantages of the present invention will become more clearly apparent upon reading the following description of particular embodiments, this description being given only by way of non-limiting example and made with reference to the accompanying diagrams in which:

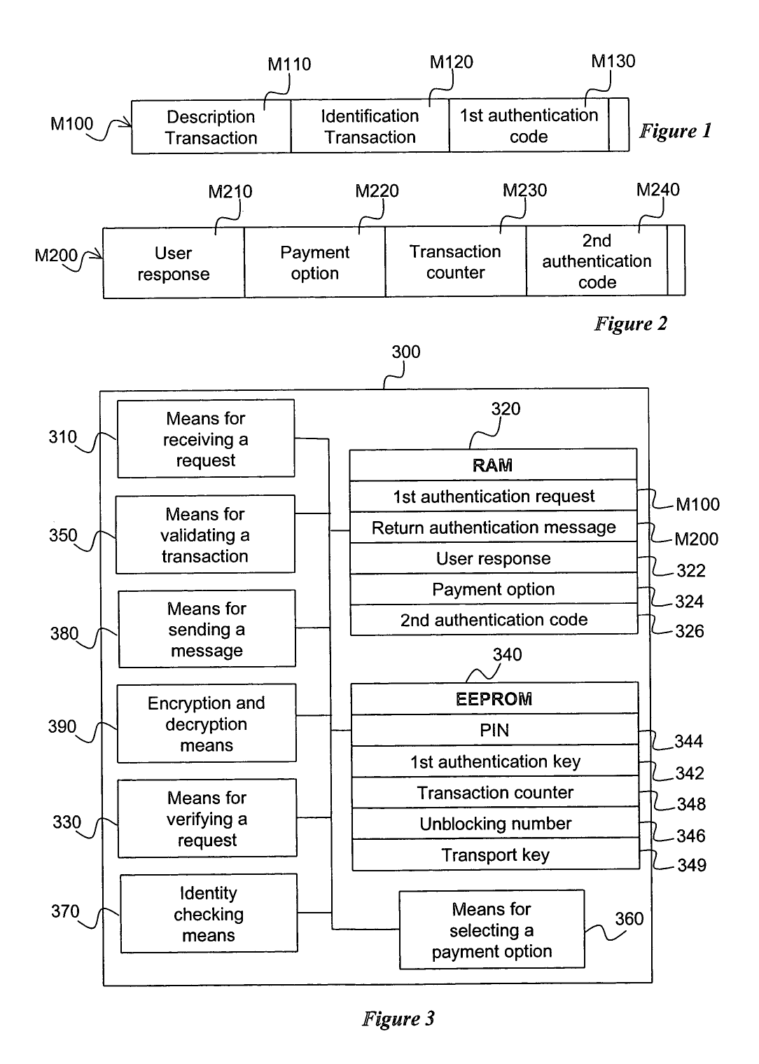

FIG. 1 schematically represents an authentication request according to the invention, in one particular form;

FIG. 2 represents a return authentication message according to the invention, in one particular form;

FIG. 3 represents an authentication device according to the invention, in one particular embodiment;

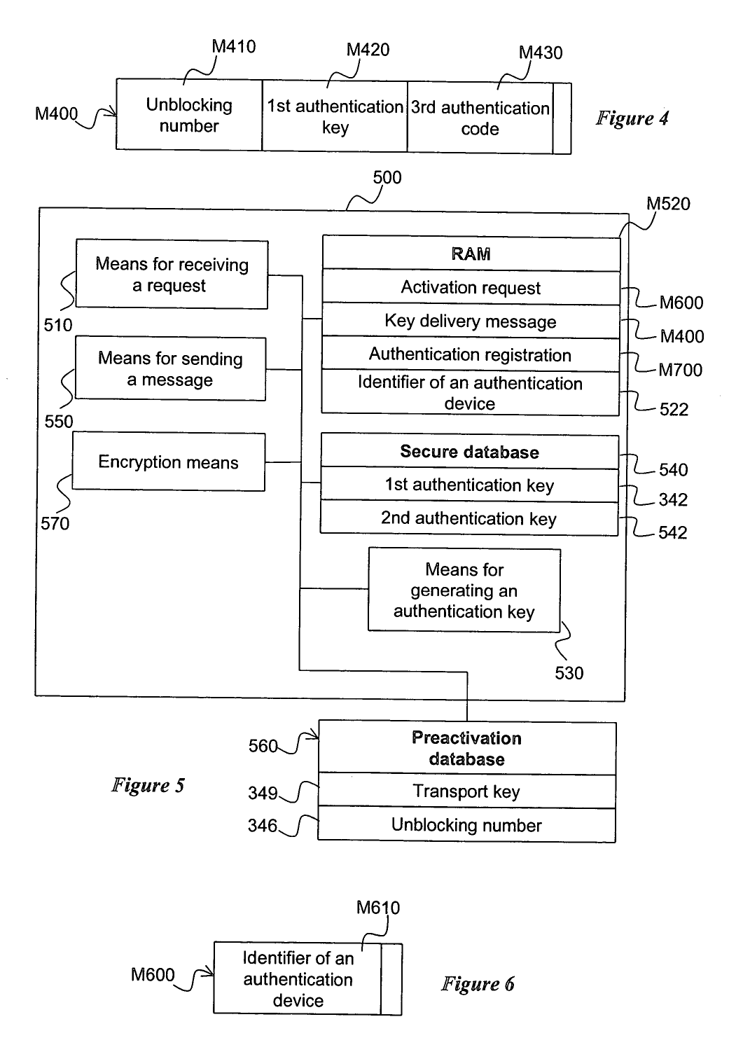

FIG. 4 represents a key delivery message according to the invention, in one particular form;

FIG. 5 represents an activation server according to the invention, in one particular embodiment;

FIG. 6 represents an activation request according to the invention, in one particular form;

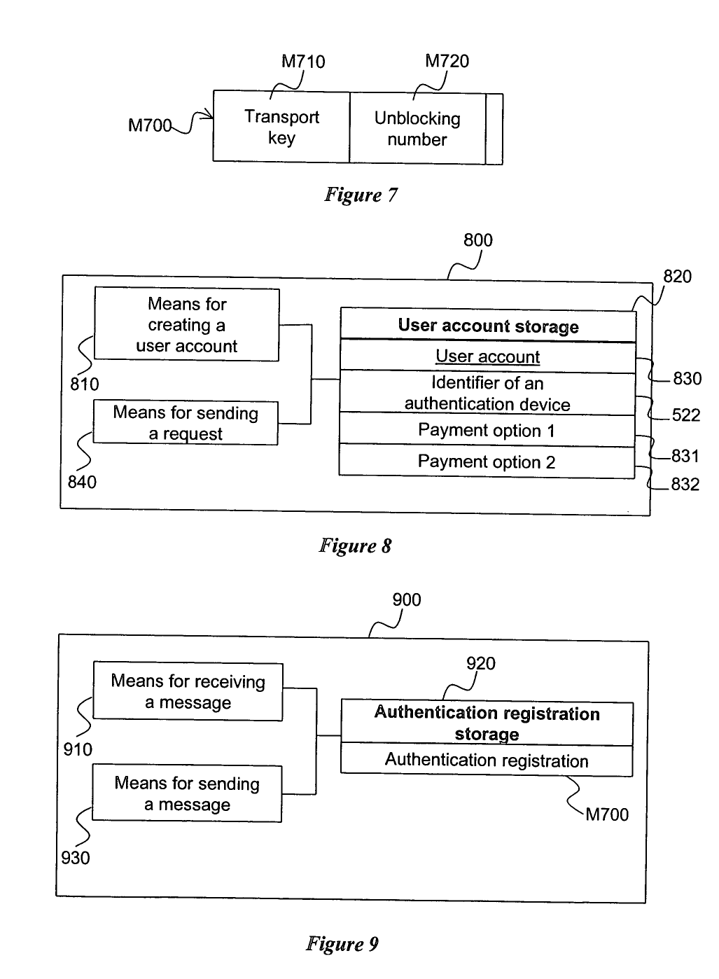

FIG. 7 represents an authentication registration according to the invention, in one particular form;

FIG. 8 represents a user account server according to the invention, in one particular embodiment;

FIG. 9 represents an authentication server according to the invention, in one particular embodiment;

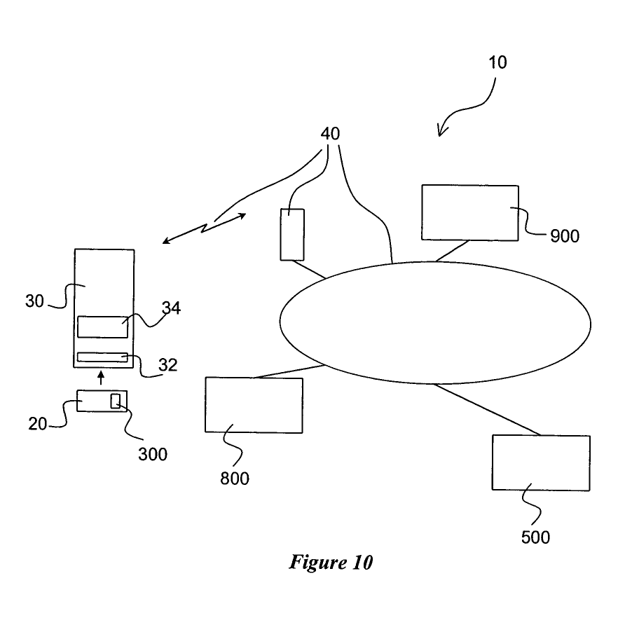

FIG. 10 represents a remote electronic payment system according to the invention, in one particular embodiment; and

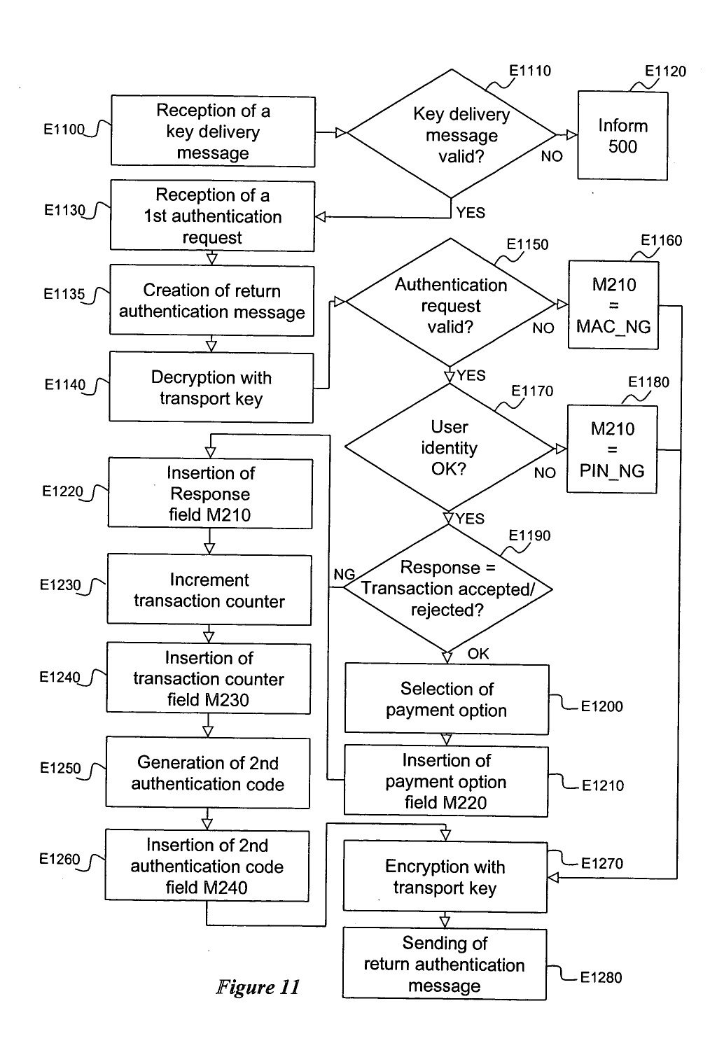

FIG. 11 is a flowchart of an authentication method according to the invention, in one particular implementation.

FIG. 1 represents an authentication request M100 according to the invention. Such an authentication request M100 includes a first field M110 containing the details of a transaction. These details are for example the references of a supplier, the transaction amount and various payment options 831, 832 illustrated in FIG. 8.

The authentication request M100 includes a second field M120 for identifying the transaction, for example in the form of a transaction number. Lastly it includes a first authentication code M130. This first authentication code M130 is used to ensure that the authentication request M100 has been sent by a valid authentication server.

FIG. 2 represents a return authentication message M200 according to the invention. Such a return authentication message M200 includes a first field M210 for the user response, representing the acceptance or rejection of the transaction described in field M110 of an authentication request M100.

The return authentication message M200 also includes a field M220 containing a payment option for the transaction. This field is of course used only if the user response field M210 is representative of the acceptance of the transaction.

The return authentication message also includes, in a field M230, the value of a transaction counter 348 of the type described later with reference to FIG. 3.

The return authentication message M200 lastly includes a second authentication code in a field M240, this code being similar to the first authentication code M130 of the authentication request M100.

FIG. 3 represents an authentication device 300 according to the invention. The authentication device 300 includes means 310 for receiving an authentication request M100 as described with reference to FIG. 1. These reception means 310 are designed to store the authentication request M100 received in a random access memory (RAM) 320.

The authentication device 300 includes means 330 for verifying the validity of the authentication request M100. These means use in particular the first authentication code M130 contained in the authentication request M100 and a first authentication key 342 stored in a register of a non-volatile memory (EEPROM) 340.

This first authentication key 342 is for example received from an activation server 500 of the type described later with reference to FIG. 5. The method implemented by the verification means 330 are known to those skilled in the art and will not be described here. These verification methods 330 are of course designed to verify any other request received by the authentication device 300 and in particular an activation request M600 of the type described later with reference to FIG. 6.

The authentication device 300 includes means 350 for validating a transaction. These means are for example designed to display the transaction details contained in the field M110 of the request M100 and to obtain a user response 322 representing the acceptance or rejection of the transaction by the user. This user response 322 is stored in the RAM 320 by the means 350 for validating a transaction.

The authentication device 300 also includes means 360 for selecting a payment option 324 from the payment options 831, 832. These means are in particular designed to provide a list of payment options 831, 832 presented in field M110 of the authentication request M100. These means 360 for selecting a payment option are also designed to store, in a register of the random access memory 320, the payment option 324 adopted by the user.

The authentication device 300 also includes means 370 for checking the identity of the user. These means are for example designed to verify, in a known manner, a personal identification number (PIN) 344 stored in a register of the non-volatile memory 340. These means 370 for checking the identity of the user are also designed to block the authentication device 300 when the user enters, three times, a personal identification number that is different from the personal identification number 344. The device 300 can then be unblocked by entering a personal unblocking identification number 346, stored in the non-volatile memory 340.

This personal unblocking identification number 346 and the first authentication key 342 are received by the authentication device 300 in fields M410 and M420 respectively of a key delivery message M400 represented in FIG. 4. The key delivery message M400 lastly includes a third authentication code M430 similar to the first authentication code M130 of the authentication request M100.

Returning to FIG. 3, the verification means 330 are also designed to verify the validity of the key delivery message M400, based on the third authentication code. The authentication device 300 also includes means 380 for sending a return authentication message M200, of the type described above with reference to FIG. 2.

These means 380 for sending a return authentication message are designed to increment, before each sending of a return authentication message M200, a transaction counter 348 contained in a register of the non-volatile memory 340.

They are also designed to generate a second authentication code 326 and to store it in a register of the random access memory 320.

The means 380 for sending a return authentication message M200 are also designed to construct such a message based on the user response 322, the payment option 324, the transaction counter 348 and the second authentication code 326, these values occupying fields M210, M220, M230 and M240 respectively.

The means 380 for sending a return authentication message are also designed to send a message M200 to an authentication server 900, of the type described later with reference to FIG. 9.

The authentication device 300 also includes encryption and decryption means 390, designed respectively to encrypt a return authentication message M200 and to decrypt an authentication request M100, based on a transport key 349 stored in a register of the non-volatile memory 340. This transport key 349 is supplied at the time of personalization of the authentication device 300.

FIG. 5 represents an activation server 500 according to the invention. An activation server 500 includes means 510 for receiving an activation request M600 represented in FIG. 6. Such an activation request M600 includes a field M610 containing an identifier of an authentication device 300. Upon receiving an activation request M600, the reception means 510 read the identifier 522 of an authentication device 300 in field M610 of this activation request M600 and store it in a register 522 of a random access memory (RAM) 520. The activation request M600 comes from a user account server 800 which will be described later with reference to FIG. 8.

Returning to FIG. 5, the activation server 500 also includes means 530 for generating an authentication key. These means 530 for generating an authentication key are in particular designed to generate the first authentication key 342 described with reference to FIG. 3.

They are also designed, in another embodiment, to generate a second authentication key 542, based on the first authentication key 342.

These means 530 for generating an authentication key are also designed to store the generated authentication keys 342 and 542 in a secure database 540.

The activation server also includes message sending means 550. These message sending means 550 are in particular designed to send an activation request M600 of the type represented in FIG. 6.

The message sending means 550 are also designed to construct and send, to the authentication device 300, upon receipt of a response to the activation request M600, a key delivery message M400, of the type described with reference to FIG. 4. To construct this message, they first write a personal unblocking identification number 346, read from a preactivation database 560, into field M410 of the key delivery message M400. The message sending means 550 then place the first authentication key 342 in field M420, and then generate a third authentication code and place it in field M430.

In a preferred embodiment, the key delivery message M400 is encrypted by encryption means 570 of the activation server 500, before it is sent by the sending means 550. The encryption means 570 use in particular the transport key 349 read from the preactivation database 560. In a particular embodiment, the transport key 349 is also used by the message sending means 550 to generate the third authentication code.

The message sending means 550 are also designed to send an authentication registration M700 represented in FIG. 7 to an authentication server 900 described later with reference to FIG. 9. The authentication registration M700 includes two fields M710 and M720 intended to contain the transport key 349 and the personal unblocking identification number 346 respectively.

The activation request M600, the key delivery message M400 and the authentication registration M700 can be stored in the random access memory 520 of the activation server 500.

FIG. 8 represents a user account server 800 according to the invention. A user account server 800 includes user account creation means 810. These creation means 810 are in particular designed to create a user account 830 and to store it in a storage area 820.

A user account 830 includes an identifier 522 of an authentication device 300 and various payment options 831, 832.

The user account server 800 also includes means 840 for sending a request. These means 840 for sending a request are in particular designed to send an activation request M600, of the type described with reference to FIG. 6, to an activation server 500. They are also designed to send a second authentication request to an authentication server 900 which will be described next.

FIG. 9 represents an authentication server 900 according to the invention. An authentication server 900 includes means 910 for receiving an authentication registration M700 from an activation server 500. These reception means 910 are designed to store an authentication registration M700 received in an authentication registration storage area 920.

The reception means 910 are also designed to receive a second authentication request from a user account server 800.

The authentication server 900 includes sending means 930 designed to send a first activation request M100, described with reference to FIG. 1, to an authentication device 300. The reception means 910 are also designed to receive a return authentication message M200 from the authentication device 300. The sending means 930 are lastly designed to send a transaction confirmation message (not represented here) to a user account server 800.

FIG. 10 represents a remote electronic payment system 10 according to the invention. Such a system 10 includes an authentication device 300, an activation server 500, a user account server 800 and an authentication server 900. In the embodiment described here, the authentication device 300 is incorporated in a SIM card 20 designed to be inserted into a slot 32 of a mobile telephone 30. The remote electronic payment system 10 uses an infrastructure of a GSM type mobile telecommunications network 40 to transport authentication requests M100, return authentication messages M200, key delivery messages M400 and activation requests M600. More specifically, the messages and requests M100, M200, M400 and M600 comply with the SMS format of the GSM protocol. The mobile telephone 30 additionally includes entry means 34, for example in the form of a keypad, for entering a personal identification number 344. In this embodiment, the identifier 522 of the authentication device 300 is the telephone number of the mobile telephone 30 associated with the SIM card 20.

FIG. 11 is a flowchart of an authentication method according to the invention.

An authentication method according to the invention includes a first step E1100 for receiving a key delivery message M400. This key delivery message M400 is received from an activation server 500. This message M400 contains an authentication key 342, a personal unblocking identification number 346 and a third authentication code in a field M430.

Step E1100 is followed by a test E1110 during which the validity of the key delivery message M400 is verified. This verification uses in particular the third authentication code received during step E1100.

If this key delivery message is not valid, the result of test E1110 is negative. This test is then followed by a step E1120 during which an information message is sent to the activation server 500.

If the key delivery message M400 is valid, the result of test E1110 is positive. This test is then followed by a step E1130 for receiving a first authentication request M100 from an authentication server 900. This first authentication request includes, among other items, a description of the transaction and a first authentication code.

This step E1130 is followed by a step E1135 for creating a return authentication message M200, the fields M210, M220, M230 and M240 of which are empty.

Step E1135 is followed by a step E1140 for decrypting the first authentication request M100 received during step E1130. This decryption step E1140 uses a transport key 349, typically supplied during a personalization step not represented here.

Step E1140 is followed by a test E1150 during which the validity of the authentication request is tested. This test E1150 uses in particular the first authentication code contained in field M130 of the authentication request received at step E1130 together with the first authentication key 342.

If this request is not valid, the result of test E1150 is negative. This test is then followed by a step E1160, during which the field M210 of the return authentication message M200 created at step E1135 is initialized with an error code “MAC_NG” that represents the receipt of an invalid authentication request. The test E1160 is then followed by a step E1270 which will be described later.

If the authentication request M100 is valid, the result of test E1150 is positive. This test is then followed by a test E1170 during which the identity of the user is verified. In a known manner, step E1170 consists in comparing a personal identification number entered by the user with a personal identification number 344, for example received by mail. If the user enters an incorrect personal identification number, for example three times, the result of test E1170 is negative. This test is then followed by a step E1180 during which the field M210 of the return authentication message M200 created at step E1135 is initialized with an error code “PIN_NG” that represents an invalid user. Step E1180 is then followed by a step E1270 which will be described later.

If the user enters a personal identification number that is identical to the personal identification number 344, the result of test E1170 is positive. This test is then followed by a step E1190. During this step, the user accepts or rejects the transaction described in field M110 of the authentication request M100 received at step E1130.

If this transaction is rejected, a “Response” variable 322 is initialized with the value NG and step E1190 is followed by a step E1220 which will be described later.

If this transaction is accepted, the “Response” variable 322 is initialized with the value OK. Step E1190 is in that case followed by a step E1200 for selecting a payment option 324. This payment option 324 is chosen from various payment options 831, 832 contained in field M110 of the authentication request M100 received at step E1130.

This payment option is then inserted in step E1210 in field M220 of the return authentication message M200 created at step E1135.

Step E1210 is followed by a step E1220, during which the value of the “Response” variable 322 is inserted in field M210 of the return authentication message M200 created at step E1135.

Step E1220 is followed by a step E1230, during which a transaction counter 348 is incremented. The value of this transaction counter 348 is inserted, during the next step E1240, in field M230 of the return authentication message M200 created at step E1135.

Step E1240 is followed by a step E1250 for generating a second authentication code, inserted during the next step E1260 in field M240 of the return authentication message created at step E1135.

Step E1260 is followed by a step E1270 for encrypting the return authentication message M200 created during step E1135. This message encryption step E1270 uses in particular the transport key 349.

Step E1270 is followed by a step E1280 for sending the return authentication message M200 to the authentication server 900 from which the authentication request M100 received during step E1130 originated.

1. Authentication device (300) for authentication with an authentication server (900) in a remote payment system (10), said authentication being prior to a transaction by a user, said device (300) being characterized in that it includes:
means (310) for receiving a first authentication request (M100) from said authentication server (900);
means (330) for verifying the validity of said authentication request (M100);
means (350) of validation, by the user, of said transaction;
means (370) for checking the identity of said user; and
means (380) for sending a return authentication message (M200) to said authentication server (900).

2. Authentication device (300) according to claim 1, said authentication request (M100) including a description of said transaction, an identifier of said transaction and a first authentication code from said authentication server (900), said device (300) being characterized in that said verification means (330) are designed to verify the validity of said authentication request (M100) from said first authentication code and from a first authentication key (342).

3. Authentication device (300) according to claim 1 or 2, characterized in that it additionally includes means (380) for generating a second authentication code (326), and in that said means (380) for sending the return authentication message (M200) are designed to insert said second authentication code (326) into said return authentication message (M240).

4. Authentication device (300) according to any one of claims 1 to 3, characterized in that said means (380) for sending the return authentication message (M200) are designed to insert a response (322) into said return authentication message (M200), said response (322) being dependent on said validation of the transaction.

5. Authentication device (300) according to any one of claims 1 to 4, characterized in that said means (370) for checking the identity of said user make use of a personal identification number (344).

6. Authentication device (300) according to any one of claims 1 to 5, characterized in that it additionally includes means (390) for decrypting said first authentication request (M100), based on a transport key (349).

7. Authentication device (300) according to any one of claims 1 to 6, characterized in that it additionally includes means (390) for encrypting said return authentication message (M200), based on a transport key (349).

8. Authentication device (300) according to any one of claims 1 to 7, said transaction including a payment operation, said device being characterized in that it additionally includes means (360) for selecting a payment option (324) for said transaction and in that said means (380) for sending the return authentication message (M200) are designed to insert said option (324) into said return authentication message (M220).

9. Authentication device (300) according to any one of claims 3 to 8, characterized in that it additionally includes a transaction counter (348) used by said means (380) for generating said second authentication code (326), and in that said means (380) for sending the return authentication message (M200) are designed to insert said transaction counter (348) into said return authentication message (M230).

10. Authentication device (300) according to any one of claims 2 to 9, characterized in that it additionally includes means (310) for receiving, from an activation server (500), a key delivery message (M400), said key delivery message (M400) including said first authentication key (342).

11. Authentication device (300) according to claim 10, characterized in that said key delivery message (M400) additionally includes a personal unblocking identification number (346).

12. Authentication device (300) according to claim 10 or 11, characterized in that it additionally includes means (330) for verifying the validity of said key delivery message (M400), based on a third authentication code contained in said key delivery message (M430).

13. Smart card, characterized in that it includes an authentication device (300) according to any one of claims 1 to 12.

14. SIM card (20), characterized in that it includes an authentication device (300) according to any one of claims 1 to 12.

15. Telephone (30), characterized in that it includes means (32) designed to receive a SIM card (20) according to claim 14.

16. Telephone (30) according to claim 15, the SIM card (20) including an authentication device (300) according to any one of claims 5 to 12, said telephone (30) being characterized in that it additionally includes means (34) for entering said personal identification number (344).

17. Activation server (500), in a remote payment system (10), characterized in that it includes:
means (510) for receiving an activation request (M600) from a user account server (800), said activation request (M600) including an identifier (522) of an authentication device (300) according to any one of claims 10 to 12;
means (530) for generating said first authentication key (342); and
means (550) for sending, on receipt of a response to said activation request (M600), said key delivery message (M400) to said authentication device (300).

18. Activation server (500) according to claim 17, characterized in that said identifier (522) is a telephone number.

19. Activation server (500) according to claim 17 or 18, characterized in that it additionally includes means (530) for saving said first authentication key (342) in a secure database (540).

20. Activation server (500) according to any one of claims 17 to 19, characterized in that it additionally includes means (530) for generating a second authentication key (542), from said first authentication key (342), and in that it includes means (530) for saving said second authentication key (542) in a secure database (540).

21. Activation server (500) according to any one of claims 17 to 20, characterized in that it additionally includes means (530) for computing a third authentication code, and in that said sending means (550) are designed to insert said third authentication code into said key delivery message (M430).

22. Activation server (500) according to any one of claims 17 to 21, said activation request (M600) including an identifier of an authentication device (522) according to claim 11 or 12, said activation server (500) being characterized in that said sending means (550) are designed to insert said personal unblocking identification number (346) into said key delivery message (M410).

23. Activation server (500) according to claim 21, characterized in that it additionally includes means (570) for encrypting said key delivery message (M400), based on a transport key (349).

24. Activation server (500) according to claim 23, characterized in that it additionally includes means (550) for obtaining said transport key (349) and a personal unblocking identification number (346) from a preactivation database (560).

25. Activation server (500) according to claim 23 or 24, characterized in that said computation means (550) are designed to compute said third authentication code based on said transport key (349).

26. Activation server (500) according to claim 24 or 25, characterized in that it additionally includes means (550) for sending an authentication registration (M700) to an authentication server (900), said authentication registration (M700) including said transport key (349) and said personal unblocking identification number (346).

27. User account server (800), in a remote payment system (10), characterized in that it includes:
means (810) for creating and storing at least one user account (830) associated with an authentication device (300) according to any one of claims 1 to 12;
means (840) for sending an activation request (M600) to an activation server (500) according to any one of claims 17 to 26; and
means (840) for sending a second authentication request to an authentication server (900).

28. User account server (800) according to claim 27, characterized in that said user account includes:
an identifier (522) of said authentication device (300); and
at least one payment option (831, 832) for said transaction.

29. Authentication server (900), in a remote payment system (10), characterized in that it includes:
means (910) for receiving at least one authentication registration (M700) from an activation server (500) according to claim 26;
means (910) for storing said authentication registration (M700);
means (910) for receiving a second authentication request from a user account server (800) according to claim 27 or 28;
means (930) for sending said first authentication request (M100) to an authentication device (300) according to any one of claims 1 to 12, on receipt of said second authentication request;
means (910) for receiving a return authentication message (M200) from said authentication device (300); and
means (930) for sending a transaction confirmation message to said user account server (800) on receipt of said return authentication message (M200).

30. Remote payment system (10), characterized in that it includes an authentication device (300) according to any one of claims 1 to 12, an activation server (500) according to any one of claims 17 to 26, a user account server (800) according to claim 27 or 28 and an authentication server (900) according to claim 29.

31. Remote payment system (10) according to claim 30, characterized in that it uses an infrastructure of a mobile telephony network (40).

32. Remote payment system (10) according to claim 31, characterized in that said mobile network (40) is a GSM network.

33. Remote payment system (10) according to claim 32, characterized in that said messages and said requests comply with the SMS format of the GSM protocol.

34. Method of authentication with an authentication server (900) in a remote payment system (10), said authentication being prior to a transaction by a user, said method being characterized in that it includes the following steps:
reception (E1130) of a first authentication request (M100) from said authentication server (900);
verification (E1150) of the validity of said authentication request (M100);
validation (Ell90), by the user, of said transaction;
check (E1170) on the identity of said user; and
sending (E1280) of a return authentication message (M200) to said authentication server (900).

35. Authentication method according to claim 34, said authentication request (M100) including a description of said transaction, an identifier of said transaction and a first authentication code from said authentication server (900), said method being characterized in that the validity of said authentication request is verified using said first authentication code and a first authentication key (342), during said verification step (E1150).

36. Authentication method according to claim 34 or 35, characterized in that it additionally includes a step (E1250) for generating a second authentication code, said second authentication code being inserted into said return authentication message (M240) during a first insertion step (E1260).

37. Authentication method according to any one of claims 34 to 36, characterized in that a response (322), dependent on said validation of the transaction, is inserted into said return authentication message (M210) during a second insertion step (E1220).

38. Authentication method according to any one of claims 34 to 37, characterized in that a personal identification number (344) is used during said step for checking the identity of said user (E1170).

39. Authentication method according to any one of claims 34 to 38, characterized in that it additionally includes a step (E1140) for decrypting said first authentication request (M100), based on a transport key (349).

40. Authentication method according to any one of claims 34 to 39, characterized in that it additionally includes a step (E1270) for encrypting said return authentication message (M200), based on a transport key (349).

41. Authentication method according to any one of claims 34 to 40, said transaction including a payment operation, said method being characterized in that it additionally includes a step (E1200) for selecting a payment option (324) for said transaction, said option (324) being inserted into said return authentication message (field M220 of M200) during a step (E1210) for inserting a payment option.

42. Authentication method according to any one of claims 36 to 41, characterized in that said step (E1250) for generating said second authentication code uses a transaction counter (348), said transaction counter (348) being inserted into said return authentication message (M230) during a step (E1240) for inserting a transaction counter.

43. Authentication method according to any one of claims 35 to 42, characterized in that it additionally includes a step (E1100) for receiving a key delivery message (M400), said key delivery message (M400) including said first authentication key (342).

44. Authentication method according to claim 43, characterized in that said key delivery message (M400) additionally includes a personal unblocking identification number (346).

45. Authentication method according to claim 43 or 44, characterized in that it additionally includes a step (E1110) for verifying the validity of said key delivery message (M400), based on a third authentication code contained in said key delivery message (M430).
